(19) United States
(12) Patent Application Publication
(10) Pub. No.: US 2007/0117072 A1
(43) Pub. Date: May 24, 2007

(54) Attitude reaction monitoring

(75) Inventors: Iqbal Adjali, Bedford (GB); Ogi Bataveljic, Bedford (GB); Marco De Boni, Bedford (GB); Malcolm Benjamin Dias, Bedford (GB); Robert Hurling, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/284,079

(22) Filed: Nov. 21, 2005

(51) Int. Cl. G09B 19/00

(52) U.S. Cl. 434/236

(57) ABSTRACT

An apparatus for explicit and implicit attitude reaction monitoring on mobile computing devices and a method of operating such devices for interacting with a user and for guiding a behaviour of the user. The method comprising presenting the user with a series of tasks, each task requiring at least one response from the user and receiving the responses to the tasks from the user. The method further comprising, determining as a function of the received responses, one or more differences in the explicit and implicit attitudes of the user towards performing an intended behaviour, and delivering at least one message to the user, as a result of the differences in attitude, so as to guide the user to perform the intended behaviour.

### FIELD OF THE INVENTION

The present invention relates to attitude reaction monitoring and interactive devices, and in particular relates to methods and apparatus for monitoring the behavioural attitude of users and facilitating dialogues on mobile computing devices.

### BACKGROUND OF THE INVENTION

It is known that human attitudes towards performing a particular behaviour or activity, such as exercising regularly, maintaining a healthy diet or reducing tobacco or alcohol consumption, are comprised of two components—an explicit attitude and an implicit attitude. The ‘explicit attitude’ relates to attitudes of which an individual is consciously aware, and the ‘implicit attitude’ relates to attitudes of which an individual is not consciously aware, i.e. sub-conscious associations which are more psychologically deep-rooted and instinctive to the individual.

It has been believed for some time in attitude-behaviour models, such as the Theory of Planned Behaviour, that human intentions are the direct precursors of behaviour, such that an intention to exercise will lead to the behaviour of attending the gym for instance. However, there is increasing evidence to suggest that automatic mental processes may directly influence behaviour without the need to form an intention, and it has been argued that both explicit and implicit attitudes can jointly direct an action to perform a behaviour.

However, as is commonly known, individuals do not always do what they say they intend to do. Hence, when differences arise between their explicit and implicit attitudes towards performing an intended behaviour, a ‘goal conflict’ can arise. This concomitant conflict reduces the likelihood that an intention (e.g. to exercise) will lead to a corresponding behaviour (e.g. jogging). The goal is the motivational source for the intention (e.g. goal (get fit)→intention (exercise)→behaviour (jogging)), and it is found that goal conflicts may be experienced at both a conscious goal level as well as an attitudinal level. The emergence of a goal conflict is problematic to an individual, as generally this may prevent them from enacting their intentions to undertake a particular behaviour, such as exercising regularly, eating more healthily, coping with stress and/or sleeping more peacefully etc.

Behavioural attitudes and goal conflicts may be assessed in laboratory environments and using dedicated internet based algorithms, available via the World Wide Web. However, although such assessments are instructive and indicative of an individual's attitude towards particular behaviours, laboratory and internet based tests are typically conducted in an artificial environment which does not take external influences and stimuli into consideration.

Humans consciously and sub-consciously react to their environment and therefore external influences and stimuli may have a direct impact on an individual's explicit and implicit attitudes towards a particular behaviour and/or achieving a specific goal.

Hence, in order to more accurately determine an individual's attitude it is better to make an assessment in situ, such that any environmental effects on the individual's attitude are taken into consideration.

Although laboratory and internet based tests may be useful in determining an individual's attitude towards a particular behaviour, they do not generally provide any form of adaptive feedback for the individual. Therefore, although attitude differences and goal conflicts may be identified, the individual is usually offered no guidance as to how to resolve the differences and conflicts, sodas to achieve their goals.

An object of the present invention is to provide a mobile computing device that can assess the explicit and implicit attitudes of a user towards performing an intended behaviour, so as to provide motivation or encouragement to the user to either perform that behaviour or discourage that behaviour.

Another object of the present invention is to provide a client application that can measure the explicit and implicit attitudes of a user of a mobile computing device based on the user's responses to a series of tasks provided by the application.

Another object of the present invention is to provide client and server side applications that are capable of managing a message content from a remote server, the message content being based on a determination of a user's explicit and implicit attitudes towards performing an intended behaviour and/or their motivational goals.

### DEFINITION OF THE INVENTION

According to an aspect of the present invention there is provided a method of operating a mobile computing device for interacting with a user and for guiding a behaviour of the user, comprising:
presenting the user with a series of tasks, each task requiring at least one response from the user;
receiving the responses to the tasks from the user;
determining, as a function of the received responses, one or more differences in attitude of the user towards performing an intended behaviour;
and
delivering at least one message to the user, as a result of the differences in attitude, so as to guide the user to perform the intended behaviour.

According to another aspect of the present invention there is provided an apparatus comprising:
a mobile computing device for interacting with a user and for guiding the behaviour of the user, including:
means for presenting the user with a series of tasks, each task requiring at least one response from the user;
means for receiving the responses to the tasks from the user;
means for determining, as a function of the received responses, one or more differences in attitude of the user towards performing an intended behaviour; and
means for delivering at least one message to the user, as a result of the differences in attitude, so as to guide the user to perform the intended behaviour;
and
a remote server for communicating with the mobile computing device, including:
means for receiving from the mobile computing device information relating to the differences in attitude of the user towards performing the intended behaviour; and
means for determining a message content, based on the received information, to be downloaded to the mobile computing device.

According to a further aspect of the present invention there is provided a mobile computing device for interacting with a user and for guiding the behaviour of the user, comprising:
means for presenting the user with a series of tasks, each task requiring at least one response from the user;
means for receiving the responses to the tasks from the user;
means for determining, as a function of the received responses, one or more differences in attitude of the user towards performing an intended behaviour;
and
means for delivering at least one message to the user, as a result of the differences in attitude, so as to guide the user to perform the intended behaviour.

According to another aspect of the present invention there is provided a remote server for communicating with a mobile computing device, comprising:
means for receiving from the mobile computing device information relating to the differences in attitude of the user towards performing an intended behaviour; and
means for determining a message content, based on the received information, to be downloaded to the mobile computing device for guiding the user to perform the intended behaviour.

### DETAILED DESCRIPTION OF THE INVENTION

Embodiments of the present invention will now be described in detail by way of example and with reference to the accompanying drawing in which:

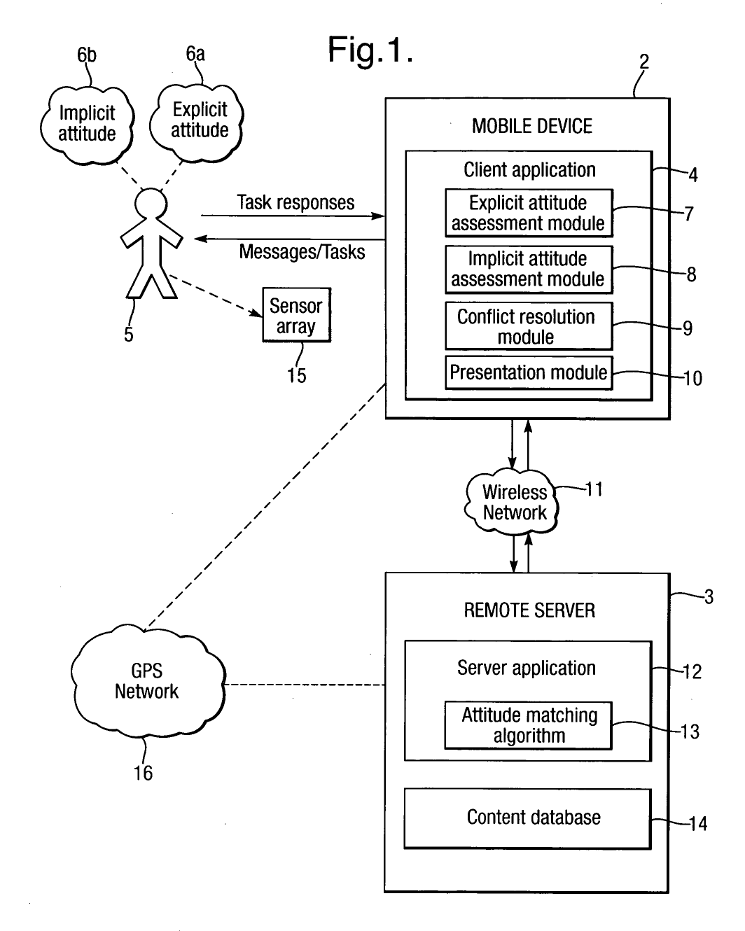

FIG. 1 is a schematic view of a particularly preferred arrangement of an attitude reaction monitoring apparatus according to the present invention.

With reference to FIG. 1 there is shown a particularly preferred arrangement of an attitude reaction monitoring apparatus 1 (hereinafter referred to as the “apparatus”) according to the present invention. The apparatus 1 comprises a mobile computing device 2 and a remote server 3, each adapted for wireless communication there between. By ‘remote’ we mean that the device 2 and the server 3 are physically separated and are disposed in different locations with respect to each other.

The mobile computing device 2 (hereinafter referred to as the ‘mobile device’) is of a kind that is capable of executing the client application 4 of the present invention, and is preferably one of the following devices: a smart mobile phone, a laptop computer, a personal digital assistant (PDA) or a tablet PC, modified in accordance with the prescriptions of the following arrangements. It is to be appreciated however, that the mobile device 2 may be any suitable portable data exchange device that is capable of interacting with a user, e.g. by providing information to the user in some form.

In exemplary arrangements, the mobile device 2 is most preferably a mobile phone capable of communicating across a cellular telecommunications network with one or more remote servers, e.g. located at base stations throughout the network.

Preferably, the client application 4 may be implemented using any suitable programming language, e.g. C, C++ or JavaScript etc. either as an application or applet, and is preferably platform/operating system independent, to thereby provide portability of the application to different mobile devices. In most preferred arrangements, it is intended that the client application 4 will be installed on the mobile device 2 by remotely accessing a suitable software repository (located on the remote server 3 or other suitable server database), and then downloading the application 4 to the device 2.

Alternatively, the client application 4 may be directly installed on the mobile device 2 by inserting a suitable media (e.g. CD-Rom, DVD, Compact Flash, Secure Digital card etc.) containing the application into the device 2.

In other arrangements, the client application 4 may be pre-installed in the mobile device 2 during manufacture, and would preferably reside on a ROM (read only memory) chip or other suitable non-volatile storage device or integrated circuit.

In accordance with the present invention, the client application 4 is operable to assess behavioural attitudes of a user 5 of the mobile device 2 by presenting the user 5 with a series of tasks, each requiring at least one response from the user 5, and determining from those responses one or more differences or goal conflicts in the attitude of the user 5 towards performing an intended behaviour.

Goal conflicts may take many forms, for example they can be represented as a discrepancy or variance between a person's:
a) explicit attitudes towards goals (e.g. getting fit) and means to obtain the goals (e.g. behaviours such as taking more exercise),
b) explicit and implicit attitudes (e.g. conscious and sub-conscious attitudes towards exercise),
c) explicit conflicting goals (e.g. conscious attitude of getting fit versus desire to relax or have fun), and
d) implicit conflicting goals (e.g. sub-conscious attitude or association with getting fit versus desire to relax or have fun).

In order to assess explicit and implicit attitudes of an individual, different tasks are required for each type of attitude. It is known that explicit attitudes are best (and most simply) assessed by way of straight-forward questionnaires, in which a predetermined sequence of questions relating to a particular behaviour or type of behaviour are presented to a user for his/her response. It is usual for the questions to be of a type that require a rating response on, for example, a 7 point scale having ‘descriptive anchors’ at opposing ends of the scale (e.g. from very pleasant to very unpleasant). However, alternatively the questions may require simple ‘yes’ or ‘no’ type or similar responses etc. Of course, any combination may be used depending on the particular application and questionnaire type.

However, questionnaire techniques are not useful in assessing implicit attitudes, and therefore these are usually assessed by way of one or more reaction time tests based on word categorisation tasks. In alternative approaches, implicit attitudes may be indirectly assessed by way of subliminal priming, to measure the influence of categories on word sorting, or via direct text analysis, e.g. word types, word combinations and/or sentence structure etc.

In preferred arrangements, the client application 4 comprises a number of different software modules or applets, including an ‘explicit attitude assessment module’ 7 (hereinafter referred to as the ‘explicit module’) and an ‘implicit attitude assessment module’ 8 (hereinafter referred to as the ‘implicit module’).

The role of the explicit module 7 is to present to the user 5, via a presentation module 10, one or more questionnaires containing a sequence of predetermined questions directed to a behaviour and each requiring a response from the user 5. The number of questions in the sequence may be any suitable number greater than 1, that is able to provide a statistically significant sample of answers so as to assess the explicit attitude 6a of the user 5 towards performing the associated behaviour.

The one or more questionnaires may be installed at the same time as the client application 4, and therefore may form part of a pre-coded set of data which is stored locally on the mobile device 2. However, in preferred arrangements, the questionnaires may be downloaded from the remote server 3, as and when required by the user 5. In this way, the user 5 can be assured that the most up-to-date versions of the questionnaires are available, which also reduces the burden on the mobile device's storage means, as only those questionnaires relating to the behaviours in which the user 5 is interested need be downloaded.

The questionnaires may be in any suitable file format, such as ASCII text, HTML, XML or any other text based format, or non-text based format, and may be compressed for retrieval and storage efficiency.

Preferably, the questions in the questionnaires require rating responses or simple yes/no answers, however provision may be made for the user 5 to supply longer answers depending on the nature of the questions and questionnaire. A typical example is to request the user 5 to rate statements against a rating scale (e.g. numbered 1 to 7) having descriptive anchors e.g. strongly agree to strongly disagree. The particular intention (e.g. to go jogging) may then be rated against the scale, such that the user 5 can then rate the statement “I intend to go jogging in the next week” at the appropriate position in the scale. Hence, if the statement is consistent with an activity that the user 5 is fully intending to do, this will then be rated at or close to the ‘strongly agree’ part of the scale by the user 5.

The questions are preferably presented to the user 5 by way of the output display of the mobile device 2, e.g. LCD or TFT screen etc. However, in other arrangements, the questions may alternatively, or in addition, be provided in an audio form, e.g. by way of a human voice synthesiser, with playback via the mobile device's speakers or headphone jack etc. In this way, the user 5 may provide verbal responses to the questions which can be interpreted by a suitable voice recognition algorithm in the explicit module 7.

Preferably, the explicit module 7 stores the responses (i.e. answers) from the user 5 on a non-volatile storage means in the mobile device 2 for analysis and assessment. Once all of the responses have been obtained from the user 5, the explicit module 7 performs a statistical analysis on the scale ratings and/or number of positive (i.e. yes) and negative (i.e. no) responses in accordance with suitable explicit attitude models, so as to assess the user's explicit attitude 6a towards performing the associated behaviour. Hence, for example, if the user 5 has requested to complete an ‘improving your diet’ questionnaire, the responses to the dietary and health related questions will be analysed and an assessment as to the user's explicit attitude 6a towards eating more healthily will be made. The results of the assessment will be stored by the explicit module 7 on a non-volatile storage means in the mobile device 2, for subsequent use.

In preferred arrangements, the implicit module 8 is operable to present to the user 5, via the presentation module 10, a series of tasks including a sequence of reaction time tests to assess the user's implicit attitude 6b towards performing the associated behaviour.

At present the most reliable procedure to assess implicit attitudes is a reaction time test based on the Implicit Association Test (IAT) devised by Greenwood, McGhee and Schwartz, 1998, Journal of Personality and Social Psychology, 74, 1464. Briefly, the IAT is a test for indirectly measuring the strength of association between a category and a valence (positive/negative) attribute via a double categorisation task, in which a user responds by depressing one of two spaced keys on a keyboard (left/right), one key corresponding to a positive attribute and the other to a negative attribute. The test relies on the assumption that, if a ‘target’ category and an attribute are highly associated (i.e. congruent), the user will respond more quickly if the positive attribute key is on the same side of the keyboard as the target category appears on the screen, than if the key is on the opposite side of the keyboard. The IAT requires one target category (e.g. flowers), one contrast category (e.g. insects) and positive and negative attributes, each represented by stimuli.

During the test, stimuli from each category and attribute are presented in random sequence, and the individual is required to assign them correctly to one of the two combined category-attribute pairs (e.g. left key for flowers-pleasant and right key for insects-unpleasant), with the pairs being successively switched so that the pair category-attribute is continuously varied during the test. The IAT provides a ‘score’ by computing the difference of the mean response times of the user between successive tasks.

Hence, for example, the individual will generally associate flowers with pleasant more quickly than flowers with unpleasant (or conversely, will be slower to associate insects with pleasant than insect with unpleasant), therefore revealing a positive implicit attitude towards flowers relative to insects.

In preferred arrangements, the implicit module 8 includes reaction time tests based on the IAT, so as to determine the user's implicit attitude 6b towards performing a particular behaviour. Preferably, the reaction time tests may be installed at the same time as the client application 4, and therefore form part of a pre-coded set of data which is stored locally on the mobile device 2. However, in preferred arrangements, the reaction time tests may be downloaded from the remote server 3, as and when required by the user 5. In this way, the user 5 can be assured that the most up-to-date versions of the reaction time tests are available, which also reduces the burden on the mobile device's storage means, as only those tests relating to the behaviours in which the user 5 is interested need be downloaded.

The reaction time tests may be standalone applets which are invoked by the implicit module 8, or else may be text based ‘definition’ files, such as XML for instance, which can be parsed and executed by the implicit module 8. In either case, the reaction time tests will be displayed via the output display of the mobile device 2, and input ‘keys’ will be allocated and notified to the user 5. By ‘keys’ we mean either physical keys on a keyboard or areas of a touch sensitive keyboard, screen or case etc., or any other suitable input means associated with the mobile device 2, e.g. left/right buttons on a mouse etc.

In mobile phone applications, the keys would be spaced apart function keys or preferably numeric digit keys on the phone's keypad, for instance.

The implicit module 8 is preferably configured to monitor and record the reaction (or response) times of the user 5 during each response to the word categorisation tests. Preferably, the implicit module 8 is programmed to measure the reaction times with a resolution below about 50 milliseconds, and most preferably about 16 milliseconds. Of course, any suitable reaction time resolution may be used depending on the particular application and the speed capability of the mobile device's processor.

It is to be appreciated however, that any suitable implicit attitude test may be used to assess the implicit attitude 6b of the user 5 of the mobile device 2, in accordance with the present invention. Other known techniques include the Extrinsic Affective Simon Task and a masked primed lexical decision task based on the goal shielding paradigm. Any of these techniques may be included as an implicit attitude test in the implicit module 8.

In preferred arrangements, the implicit module 8 is configured to also ‘measure’ the degree of ‘goal shielding’ the user 5 may possess from an analysis of the responses to the reaction time tests. By ‘goal shielding’ we mean the ability of an individual to implicitly shield ‘target’ goals (e.g. getting fit) from other implicit goals (e.g. having fun/drinking alcohol etc.). Therefore, the implicit module 8 may also provide an assessment of the user's goal shielding ability, which may be instructive when combined with knowledge of any goal conflicts and differences in the user's attitudes towards performing an associated behaviour.

Due to the differing nature of the explicit and implicit attitude assessment techniques used in the present invention, it is possible to separate the corresponding tasks so that explicit attitude assessment is performed at a different time to the implicit attitude assessment. Hence, the user 5 may complete the questionnaire at a time that is most convenient for them, and indeed need not complete all the questions in one sitting. The responses to the questionnaire obviously have no associated ‘reaction time’ and therefore, the questions may be answered all together or piecemeal as desired.

Therefore, in accordance with the present invention, the explicit attitude 6a of a user 5 towards performing an intended behaviour may be assessed prior to (or after) any assessment of the implicit attitude 6b of the user 5.

Of course, it is clear that a particular reaction time test should preferably be completed in the same sitting, as the eventual score of the test is dependent on the reaction times of the user 5, which is important in the assessment of the implicit attitude 6b of the user 5.

In preferred arrangements, when the reaction time tests have been completed, the results (or scores etc.) from the one or more tests are analysed by the implicit module 8, so as to provide an assessment of the user's implicit attitude 6b towards performing the associated behaviour. The results of the assessment are preferably stored on a non-volatile storage means in the mobile device 2.

Preferably, when both the explicit and implicit modules 7, 8 notify the client application 4 that they have concluded their respective attitude assessments, the client application 4 causes the results of their assessments to be passed to a conflict resolution module 9. In preferred arrangements, the conflict resolution module 9 forms part of the coding of the client application 4, but may alternatively be a separate module that is linked to the client application 4 during execution for instance.

The conflict resolution module 9 inspects and compares the results of the attitude assessments from the explicit and implicit modules 7, 8 and determines from the results one or more differences or conflicts in, or between, the explicit and implicit attitudes of the user 5 towards performing an associated behaviour. In this regard, any knowledge of the user's goal shielding ability may also be considered by the conflict resolution module 9, as this can be instructive in identifying main points of conflict preventing a user 5 from achieving their goal by not being sufficiently motivated to perform the intended behaviour.

In preferred arrangements, when the conflict resolution module 9 has identified the conflicts and categorised them using any suitable filtering algorithm, e.g. to rank them in order of highest to lowest priority (having regard to the user's intended behaviour as deduced from the one or more questionnaires), the client application 4 may then either cause the mobile device 2 to deliver a message to the user 5 from a collection of locally stored messages, or may establish a communications session with the remote server 3, in order to download suitable message content related to the intended behaviour.

In accordance with the present invention, the client application 4 delivers to the user 5 of the mobile device 2, message based ‘therapy programmes’ which are intended to help and guide the user 5 to overcome any conflicts they may have towards performing an intended behaviour. These therapy programmes are preferably based on standard Cognitive Behavioural Therapy protocols, and can be as basic as providing simple sentences of encouragement and/or motivation. Alternatively, the programmes can be comprised of deliberate punishment and reinforcement messages, which can reprimand or reward the user 5 depending on the nature of the intended behaviour and conflict between the user's explicit and implicit attitudes 6a, 6b.

Preferably, the client application 4 will determine whether any therapy programmes stored on the mobile device 2 are suitable to address the user's conflicts in attitude. If one or more programmes are found to be appropriate then the client application 4 will preferably notify the user 5, that a suitable ‘therapy’ is available and will wait until the user 5 requests the therapy to be started. Preferably, the messages will be delivered to the output display of the mobile device 2 via the presentation module 10, which will format and size the messages etc. as appropriate for the dimensions of the output display.

The messages may be shown as a ‘slideshow’ of textual and/or graphical/pictorial information (depending on the amount of information to be delivered), and they may also include animations etc. Moreover, the messages may alternatively, or in addition, be in the form of audio output which can be delivered to the user 5 by way of the mobile device's speakers or headphone jack etc.

If the client application 4 determines that no suitable therapy programmes are stored locally on the mobile device 2, then it can request a download from the remote server 3, via a communications session established across the wireless network 11. The wireless network 11 may be any suitable wireless communications network, which in the case of mobile phone applications would typically be a cellular telecommunications network.

Having established a communications session with the remote server 3, via conventional handshaking protocols with the server application 12, the client application 4 transmits from the mobile device 2 to the server 3, information relating to the differences in attitude of the user 5, identifying the intended behaviour and including any knowledge of the user's goal shielding ability.

The transmitted information may be in any suitable file format, such as text based formats, ACSII text, HTML and XML etc. and may be compressed to shorten transmission time etc.

The server application 12 is preferably implemented using any suitable programming language and is preferably platform/operating system independent, so as to ease portability of the application to different architectures and systems. In preferred arrangements, the server application 12 includes at least one ‘attitude matching algorithm’ 13 which is operable to locate and manage message content relating to the intended behaviour indicated to it by the client application 4.

The attitude matching algorithm 13 is preferably configured to determine a message content having regard to the user's conflicts in attitude and goal shielding ability. Hence, for example, if the client application 4 has indicated to the server application 12 that the user 5 has an intended behaviour of going to the gym, but has a conflict with wanting to go to the pub instead, the server application 12 will locate a therapy programme which offers helpful guidance on focussing on the user's goal of getting fit, which may also contain warnings and information about excessive intake of alcohol etc.

In preferred arrangements, the server 3 includes one or more content databases 14, which are adapted to contain a plurality of message based therapy programmes and other suitable guidance material and resources for helping and guiding a user 5 to perform one or more intended behaviours.

Once the attitude matching algorithm 13 has located a suitable message content (e.g. therapy programme etc.), the server application 12 sends the content to the mobile device 2 via the wireless network 11, which is downloaded by the client application 4 and processed by the presentation module 10 for delivery to the user 5.

In accordance with the present invention, one or more of the message based therapy programmes are preferably adapted to teach and guide the user 5 to recognise situations in which their implicit attitudes dominate and lead to conflicts with their explicit attitudes towards performing an intended behaviour. Hence, those user's with weaker goal shielding abilities could engage in a series of deliberate punishment and reinforcement message activities, to encourage successful shielding of target goals (e.g. getting fit) from other implicit goals (e.g. relaxing). The message based guidance would provide positive feedback (i.e. a reward) when the target goal is shielded and negative feedback (i.e. a punishment) when it is not shielded. The reward and punishment preferably being textual and/or audible in nature.

It is to be appreciated that if no conflicts are determined by the conflict resolution module 9, then the user 5 can be presented with rewarding and positive motivational feedback, without the need to invoke a message based therapy programme.

In other preferred arrangements, a number of modifications could be made to the apparatus 1, so as to be more responsive to the user 5 so as to provide more appropriate help and guidance by way of message based therapies. Referring again to FIG. 1, there is shown a sensor array 15 associated with the mobile device 2. By ‘associated’ we mean either physically connected by a hardwire link, wirelessly connected by wireless protocols (e.g. Bluetooth, WiFi), physically attached to the mobile device 2 or else forming an integral part of the mobile device 2.

The sensor array 15 preferably contains one or more biometric sensors, including a skin chemical monitoring sensor, a heart rate monitoring sensor and a user imaging device (e.g. CCD camera). The use of biometric sensors provides an additional technique of assessing a user's implicit attitudes towards performing intended behaviours. Preferably, this additional technique is used in conjunction with the implicit attitude tests as described previously in relation to the operation of the implicit module 8.

It is to be appreciated that any suitable sensor or sensor type may be used in the sensor array 15 associated with the mobile device 2, in accordance with the present invention.

The one or more biometric sensors are able to determine the user's sub-conscious reactions to external stimuli, since the chemical constituents of human perspiration, human heart rate and pupil dilation for instance can change rapidly in response to certain questions and physical interactions. Moreover, humans also react to their environment and ambient conditions. Hence, in accordance with the present invention, the client application 4 is configured to receive real-time data relating to physical attributes of the user 5, which may then be used in conjunction with the results of the implicit attitude tests to determine conflicts in, or between, the explicit and implicit attitudes of the user 5 of the mobile device 2 towards performing an intended behaviour.

In preferred arrangements, the sensor data from the sensor array 15 is provided to the client application 4, where it is then processed using standard algorithms (e.g. facial recognition, voice recognition etc.) as appropriate, before being provided to the implicit module 8, where an assessment of the user's implicit attitudes 6b is made.

By ‘physical attributes’ we mean physiological and/or any underlying psychological characteristics of an individual, including, but not limited to, health indicators (such as heart rate, breathing pattern etc.), facial features (including eye movement, pupil dilation etc.), voice speech pattern (including intonation, grammar etc.), perspiration content, posture (e.g. head, shoulders) and personality type etc.

A significant advantage of the present invention is that due to the portability of the mobile device 2, the implicit attitudes of the user 5 may be assessed in situ (e.g. whilst shopping, at the gym, in the office, in the pub etc.), such that the user 5 will be sub-consciously reacting to their environment and ambient conditions, which can have significant effects on the way a person behaves or acts, which in turn can alter how they pursue and/or shield goals.

For instance, an individual may be sitting in their office with the intention of going to the gym after close of business, but on route to the gym they pass by a pub, which sub-consciously triggers thoughts of having fun and therefore they opt for the implicit goal of having fun instead of going to the gym. In this example, it is clear that the individual has weak goal shielding concerning getting fit.

In preferred arrangements, the mobile device 2 may include a location tracking device, preferably a global positioning system (GPS) based transceiver, which is able to monitor the location of the user 5 and provide location data to the client application 4. The GPS location data may be provided directly to the mobile device 2 from the GPS network 16, or else could be routed via the remote server 3 for transmission to the mobile device 2, as shown in FIG. 1.

Having knowledge of the user's location is useful, as the implicit attitude tests may be adapted to be location specific so that they are tuned to the user's environment and ambient conditions. Therefore, should a user 5 choose to undertake an implicit attitude test while in the office for instance, the client application 4 would know where the user 5 is located and hence adapt the test to be appropriate to an office environment, e.g. could use stress or deadline related stimuli etc. The test adaptation could be performed within the implicit module 8, by modifying the contents of the word categorization tests for instance, or else the client application 4 may request a more appropriate test to be downloaded from the remote server 3, as necessary.

Knowledge of the user's location is also useful in tailoring the message based therapy, as the messages can be adapted to suit the user's environment or to address specific goal conflicts that have arisen due to environmental influences etc. For instance, returning to the earlier example of the individual opting to go to the pub as opposed to the gym, the client application 4 would be aware that the individual is not performing the intended behaviour (i.e. going to the gym) and is instead residing in a drinking establishment. Therefore, the client application 4 could automatically deliver one or more messages to the user 5 through the mobile device 2, either encouraging the user 5 to ‘drink up’ and go to the gym and/or reprimanding the user 5 for not sufficiently shielding their goal (i.e. getting fit/losing weight) from other implicit goals (like having fun).

In accordance with the present invention, the client application 4 is adapted to ‘learn’ what type or types of message based therapy is, or are, most effective with a particular user 5. This is achieved by monitoring any changes in their explicit and implicit attitudes towards performing intended behaviours and through monitoring changes in how they actually behave or act. Therefore, in preferred arrangements, the client application 4 maintains historical data related to the attitudes and goal shielding ability of the user 5, so as to determine how the user's attitudes and ability change over time, so that improvements can be rewarded, whereas poor performance can be addressed and/or reprimanded by suitable message based therapy.

The historical data is preferably stored locally in a non-volatile storage means on the mobile device 2, or else can be transmitted to the remote server 3 for storage and subsequent analysis and reference.

Although the present invention is ideal for assessing explicit and implicit attitudes of individuals by attitude reaction monitoring on a mobile device, it will be recognised that one or more of the principles of the invention could be used in other applications, for instance, the apparatus could be extended to include other psychological constructs, such as perceived behavioural control (perception that you can control your behaviour) and subjective norm (perception of what other individuals want you to do) etc.

Moreover, the apparatus could be configured to include the association of target behaviours with positive stimuli, in order to increase the positivity of an implicit attitude towards the behaviour.

What is claimed is:

1. A method of operating a mobile computing device for interacting with a user and for guiding a behaviour of the user, comprising:
presenting the user with a series of tasks, each task requiring at least one response from the user;
receiving the responses to the tasks from the user;
determining, as a function of the received responses, one or more differences in attitude of the user towards performing an intended behaviour;
and
delivering at least one message to the user, as a result of the differences in attitude, so as to guide the user to perform the intended behaviour.

2. The method of claim 1, wherein the differences in attitude are differences between explicit and implicit attitudes of the user towards performing the intended behaviour.

3. The method of claim 1, wherein presenting the user with a series of tasks includes:
presenting the user with a sequence of predetermined questions for assessing the explicit attitude of the user towards performing the intended behaviour.

4. The method of claim 1, wherein presenting the user with a series of tasks includes:
presenting the user with a sequence of reaction time tests for assessing the implicit attitude of the user towards performing the intended behaviour.

5. The method of claim 4, wherein the sequence of predetermined questions are presented at a different time to that of the sequence of reaction time tests.

6. The method of claim 4, further comprising:
measuring the reaction times of the user in a word categorisation test.

7. The method of claim 6, wherein measuring includes measuring the reaction times at a resolution of below about 5 milliseconds.

8. The method of claim 6, wherein the word categorisation test is based on the Implicit Association Test.

9. The method of claim 1, wherein determining includes:
assessing, from an analysis of the received responses, explicit and implicit attitudes of the user towards performing the intended behaviour; and
comparing the explicit and implicit attitudes of the user to identify differences in attitude therebetween.

10. The method of claim 9, wherein assessing includes:
measuring the user's ability to implicitly shield a goal relating to the intended behaviour.

11. The method of claim 10, wherein a content of the at least one message is dependent on the user's goal shielding ability.

12. The method of claim 1, further comprising:
receiving real-time data relating to physical attributes of the user; and
using the data relating to the physical attributes in conjunction with the received responses to the tasks in determining the one or more differences in attitude of the user towards performing the intended behaviour.

13. The method of claim 1, further comprising:
establishing a communications session with a remote server;
transmitting to the server information relating to the differences in attitude of the user towards performing the intended behaviour;
determining, at the server, a message content based on the transmitted information; and
downloading the message content to the mobile computing device.

14. The method of claim 13, wherein the transmitted information further includes data relating to the physical attributes and/or location of the user.

15. The method of claim 13, wherein determining a message content includes identifying guidance material on the server specific to the intended behaviour.

16. The method of claim 1, wherein delivering includes presenting the message to the user in a textual and/or audible format.

17. The method of claim 1, further comprising:
detecting a location of the mobile computing device; and
modifying a content of at least one of the tasks, in the series of presented tasks, as a function of the detected location.

18. The method of claim 17, wherein the modifying includes changing the content of a reaction time test.

19. An apparatus comprising:
a mobile computing device for interacting with a user and for guiding the behaviour of the user, including:
means for presenting the user with a series of tasks, each task requiring at least one response from the user;
means for receiving the responses to the tasks from the user;
means for determining, as a function of the received responses, one or more differences in attitude of the user towards performing an intended behaviour; and
means for delivering at least one message to the user, as a result of the differences in attitude, so as to guide the user to perform the intended behaviour;
and
a remote server for communicating with the mobile computing device, including:
means for receiving from the mobile computing device information relating to the differences in attitude of the user towards performing the intended behaviour; and
means for determining a message content, based on the received information, to be downloaded to the mobile computing device.

20. The apparatus of claim 19, wherein the mobile computing device is one of the following devices: a mobile phone, a laptop, a PDA and a tablet PC.

21. The apparatus of claim 19, wherein the mobile computing device further includes means for detecting a location of the device.

22. A mobile computing device for interacting with a user and for guiding the behaviour of the user, comprising:
means for presenting the user with a series of tasks, each task requiring at least one response from the user;
means for receiving the responses to the tasks from the user;
means for determining, as a function of the received responses, one or more differences in attitude of the user towards performing an intended behaviour;
and
means for delivering at least one message to the user, as a result of the differences in attitude, so as to guide the user to perform the intended behaviour.

23. The device of claim 22, further comprising one or more biometric sensors for determining physical attributes of the user.

24. The device of claim 22, further comprising means for detecting a location of the device.

25. A remote server for communicating with a mobile computing device, comprising:
means for receiving from the mobile computing device information relating to the differences in attitude of the user towards performing an intended behaviour; and
means for determining a message content, based on the received information, to be downloaded to the mobile computing device for guiding the user to perform the intended behaviour

26. Apparatus as described substantially herein with reference to the accompanying drawings.
